(19) United States
(12) Patent Application Publication
(10) Pub. No.: US 2004/0002318 A1
(43) Pub. Date: Jan. 1, 2004

(54) Apparatus and method for calibrating image rejection in radio frequency circuitry

(76) Inventors: Donald A. Kerth, Austin, TX (US); G. Diwakar Vishakhadatta, Austin, TX (US)

Correspondence Address: INGRASSIA FISHER & LORENZ, P.C., 7150 E. CAMELBACK, STE. 325, SCOTTSDALE, AZ, 85251, US

(21) Appl. No.: 10/452,192

(22) Filed: Jun. 2, 2003

Related U.S. Application Data
(60) Provisional application No. 60/384,644, filed on May 31, 2002.

(51) Int. Cl. H04B 1/10

(52) U.S. Cl. 455/302; 375/346

(57) ABSTRACT

Methods and apparatus are provided for image rejection correction in a radio frequency (RF) receiver (100). The RF receiver (100) receives an RF input signal and converts the RF input signal to an input signal at another frequency. A tone signal is generated at an image frequency. The tone signal is mixed with an RF tuning signal to provide an image signal. The image signal is corrected using an image correction network (202) having first and second coefficients to provide a corrected signal. A wanted energy level of the corrected signal is determined. Best values of the first and second coefficients are determined in response to the wanted energy level of the filtered signal. The input signal is corrected using the best values in the image correction network (202).

### CROSS-REFERENCE TO RELATED APPLICATIONS

This application claims the benefit of U.S. Provisional Application No. 60/384,644, filed May 31, 2002, which is incorporated herein by reference in its entirety.

### TECHNICAL FIELD

The present invention generally relates to radio frequency (RF) receivers, and more particularly relates to RF receivers that perform image rejection.

### BACKGROUND

Radio frequency (RF) devices transmit a useful signal from one point to another by moving the useful signal to a more suitable signal frequency range for transmission over the medium being used. This process is known as modulation. As used herein, “radio frequency signal” means an electrical signal conveying useful information and having a frequency from about 3 kilohertz (kHz) to thousands of gigahertz (GHz), regardless of the medium through which such signal is conveyed. Thus an RF signal may be transmitted through air, free space, coaxial cable, fiber optic cable, etc. An RF transmitter mixes the desired signal, known as the baseband signal, with an RF oscillator signal for transmission over the selected medium. An RF receiver then mixes the signal with the carrier frequency to restore the signal to baseband.

To minimize the cost of the receiver it is desirable to minimize circuit complexity and low-cost complementary metal oxide semiconductor (CMOS) integrated circuits (ICs). However highly efficient demodulation techniques such as direct down conversion are not well suited for use with CMOS technology because of the poor low-frequency noise characteristics of CMOS transistors. Thus more traditional radio architectures that convert the RF radio signal to an intermediate frequency (IF) signal before converting the IF signal to baseband are usually preferred if CMOS technology is used.

In one known architecture, an RF receiver uses a relatively low IF of 100 kilohertz (kHz). While suitable for integration using CMOS ICs, using an IF that low requires a high quality notch filter with a narrow passband centered around 100 kHz to remove zero frequency (DC) offsets seen in the IF section or conversely, a narrow high pass filter in the IF section. Such a filter is attainable using digital signal processing (DSP) techniques. However it has a long settling time after the filter's parameters were changed. Furthermore, the receiver still has problems with low frequency noise since 100 kHz IF is still sufficiently close to the 1/f corner of CMOS transistors.

An alternate architecture uses a higher IF of 200 kHz. Use of this higher IF solves the problems of the 100 kHz IF receiver described above. However it adds a new problem: it requires a higher image rejection. The image rejection requirement for a Global System for Mobile communication (GSM) or general packet radio service (GPRS) at a 200 kHz low IF is 50 decibels (dB), but only 32 dB for GSM/GPRS at a 100 kHz IF. In general DC conversion and low IF receivers require less image rejection but suffer from poor sensitivity due to DC or 1/f noise sources. Higher IF architectures have better sensitivity but higher image rejection requirements.

Accordingly, it would be desirable to have an IF receiver capable of using a higher IF wherein the higher image rejection is easily achieved. This and other desirable features and characteristics of the present invention will become apparent from the subsequent detailed description and the appended claims, taken in conjunction with the accompanying drawings and the foregoing technical field and background.

### BRIEF SUMMARY

A radio frequency (RF) receiver is provided that comprises an image signal synthesizer, a down converter, and a signal processor. The image signal synthesizer has an output for providing a tone signal at an image frequency. The down converter has an input for receiving an RF input signal during a normal operation period and the tone signal during a calibration period, and an output for providing an input signal at another frequency. The signal processor has an input coupled to the output of the down converter, and an output for providing a corrected signal. The signal processor includes an image correction network. The image correction network has first and second coefficients. During the calibration period the signal processor determines best values of the first and second coefficients in response to a wanted energy level of the RF input signal signal. During the normal operation period the image filter filters the IF signal using the best values.

A method is also provided for image rejection correction in a radio frequency (RF) receiver. The RF receiver receives an RF input signal and converts the RF input signal to an input signal at another frequency. A tone signal is generated at an image frequency. The tone signal is mixed with an RF tuning signal to provide an image signal. The image signal is corrected using an image correction network having first and second coefficients to provide a corrected signal. A wanted energy level of the corrected signal is determined. Best values of the first and second coefficients are determined in response to the wanted energy level of the filtered signal. The input signal is corrected using the best values in the image correction network.

### BRIEF DESCRIPTION OF THE DRAWINGS

The present invention will hereinafter be described in conjunction with the following drawing figures, wherein like numerals denote like elements, and

FIG. 1 illustrates in partial block diagram and partial schematic form a radio receiver according to the present invention;

FIG. 2 illustrates in partial block diagram and partial schematic form a portion of the radio receiver of FIG. 1 useful in understanding the operation of the image rejection function;

FIG. 3 illustrates in block diagram form an implementation of the image correction network of FIG. 2.

FIG. 4 illustrates in partial block diagram and partial schematic form an analog circuit implementation of the image correction network of FIG. 2;

FIG. 5 is a graph illustrating a method for selection of the μ coefficient; and

FIG. 6 is a graph illustrating a method for selection of the v coefficient.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

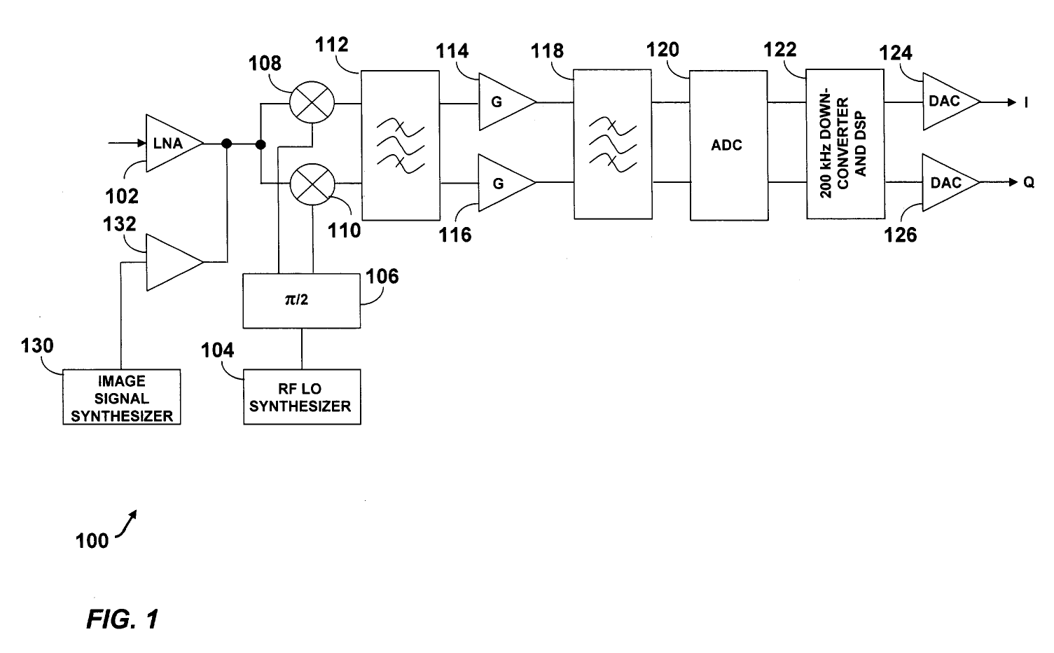

FIG. 1 illustrates in partial block diagram and partial schematic form a radio receiver 100 according to the present invention. Receiver 100 includes generally a low noise amplifier (LNA) 102, a radio frequency (RF) local oscillator synthesizer 104, a quadrature frequency generator labeled “π/2” 106, first and second mixers 108 and 110, a bandpass filter block 112, a first programmable gain amplifier labeled “G” 114, a second programmable gain amplifier labeled “G” 116, a bandpass filter block 118, an analog-to-digital converter (ADC) block 120, a 200 kilohertz (kHz) down-converter and digital signal processor (DSP) 122, and digital-to-analog converters (DACs) 124 and 126. LNA 102 has an input terminal for receiving an RF input signal from an antenna (not shown in FIG. 1), and an output terminal. RF LO synthesizer 104 has an output for providing a signal for tuning the input signal to an intermediate frequency of 200 kHz, and an output. Quadrature frequency generator block 106 has an input connected to the output of RF LO synthesizer 104, a first output for providing a first mixing signal, and a second output for providing a second mixing signal that is phase delayed from the first input mixing signal by 90 degrees. Mixer 108 has a first input terminal connected to the output terminal of LNA 102, a second input terminal for receiving the first mixing signal, and an output terminal. Mixer 110 has a first input terminal connected to the output terminal of LNA 102, a second input terminal for receiving the second mixing signal, and an output terminal.

Elements 104, 106, 108, and 110 operate to down convert the RF input signal to another frequency, in this case a 200 kHz IF. The output terminals of mixers 108 and 110 collectively provide a signal down converted to the chosen IF in the form of an in-phase component and a quadrature component, respectively. Bandpass filter block 112 is shown as a single block for receiving this signal but actually includes two separate bandpass filters having input terminals respectively connected to the output terminals of mixers 108 and 110, and corresponding first and second output terminals. This bandpass filter architecture is known as a real bandpass filter. Alternatively bandpass filter block 112 could be implemented as a single, complex bandpass filter. Also bandpass filter 112 can be a lowpass filter.

Amplifiers 114 and 116 have input terminals connected to the first and second output terminals of bandpass filters 112, and corresponding output terminals. Bandpass filter block 118 includes two separate bandpass filters having input terminals respectively connected to the output terminals of amplifiers 114 and 116, and corresponding first and second output terminals. ADC block 120 includes two separate ADCs having input terminals respectively connected to the first and second output terminals of bandpass filter block 118, and corresponding first and second output terminals. 200 kHz down-converter and DSP 122 has first and second input terminals respectively connected to the first and second output terminals of ADC block 120, and first and second output terminals. DAC 124 has an input terminal connected to the first output terminal of 200 kHz down-converter and DSP 122, and an output terminal for providing an analog in-phase output signal labeled “I”. DAC 126 has an input terminal connected to the second output terminal of 200 kHz down-converter and DSP 122, and an output terminal for providing an analog quadrature output signal labeled “Q”.

In operation, receiver 100 receives an RF signal from an antenna (not shown in FIG. 1) and converts it into baseband analog I and Q signals for further processing. In the example of a GSM receiver, the RF input signal is a time division multiple access (TDMA) signal at, for example 900 MHz. Thus RF LO synthesizer 104 generates a mixing frequency capable of mixing the desired channel down to the IF of 200 kHz. Blocks 112, 113, 116, and 118 process the IF signal in the analog domain. ADC 120 converts this processed IF signal to the digital domain for down conversion and further processing in block 122. Block 122 implements a 200 kHz notch filter which advantageously has a short settling time when using an IF of 200 kHz. The baseband digital signals are reconverted into analog signals in DACs 124 and 126 for output as standard analog I and Q signals. In addition to the notch filter, block 122 includes a correction network designed to correct for gain and phase errors seen in the analog processing blocks during normal operation, as will be more fully described below.

Receiver 100 includes several main features. It uses a low IF architecture, and in this example the low IF is 200 kHz, but it should be appreciated that this IF is only exemplary and other IF values may be used. In addition the image rejection correction feature to be described more fully below is also applicable to direct down conversion architectures. Block 106 provides a divide by 2, 4, or 8 LO quadrature generation. Thus synthesizer 104 can provide an output frequency that allows receiver 100 to be adapted for different applications. For example, there are four different bands used for the GSM cellular phone standard and block 106 allows them all to be accommodated in a single receiver. As will be described more fully below, it also provides an image rejection calibration function.

By moving to a 200 kHz low IF architecture, receiver 100 has significant advantages over a 100 kHz low IF architecture. It has an improved noise figure for low frequency noise. The main noise contributor in the down converter mixer and the IF circuitry is so-called 1/f or flicker noise. Moving to a higher IF of 200 kHz reduces this dominant noise source. Overall the sensitivity of the radio is improved with a 200 kHz IF, especially if receiver 100 is implemented in CMOS technology.

The settling times also improve. A low IF architecture receiver requires a notch filter or something equivalent to a notch filter such as an offset calibration routine to remove residual zero frequency (DC) offsets seen in the analog signal path. For a 100 kHz low IF architecture, the notch is at 100 kHz and is very narrow due to the proximity to the channel of interest. A very narrow notch filter has a long settling time constant. Therefore power up transients or analog gain change transients are very long in a 100 kHz low IF architecture. In some applications such as General Packet Radio Services (GPRS) which may require gain changes between concatenated slots, gain changes are required to settle in less than 25 microseconds. For a 200 kHz low IF architecture, the notch is placed at 200 kHz, which is 100 kHz away from the wanted channel's band edge. The width of the notch can be increased greatly, thus improving its settling time. Power up transients and analog gain changes are extremely fast for a 200 kHz low IF architecture.

Receiver 200 also offers improved amplitude modulation (AM) suppression, especially in some applications like GSM which uses TDMA. The distortion caused by an unwanted TDMA signal is mixed to 200 kHz in a 200 kHz low IF architecture. Having this distortion 100 kHz away from the wanted signal's band edge means less energy can bleed into the channel of interest and therefore any corruption of the wanted signal by a TDMA unwanted signal is reduced.

Further receiver 200 offers improved performance in Enhanced Data GSM Environment (EDGE) applications. EDGE performance (sensitivity and co-channel) is improved with channelization filters that have a bandwidth greater that the typical GMSK (Gaussian Minimum Shift Keying) channel filters used in GSM. The optional channelization filter for EDGE may require a bandwidth greater than 100 kHz. A 100 kHz low IF architecture restricts the channel filter to a bandwidth less than 100 kHz due to the placement of the notch filter. By moving to a 200 kHz IF, this restriction is removed.

Receiver 100 additionally includes an image signal synthesizer 130 and an amplifier 132. Image signal synthesizer 130 provides a tone signal at an image frequency labeled “f_{IMAGE}”. Amplifier 132 has an input terminal connected to the output terminal of image signal synthesizer 130, and an output terminal connected to the input terminals of mixers 108 and 110. For receiver 100 with a 200 kHz IF, f_{IMAGE} is equal to two times 200 kHz below the desired channel's frequency. Thus when the desired channel is mixed to the IF frequency of 200 kHz, the tone frequency would be at −200 kHz and thus would form an image at 200 kHz that may distort the desired channel information if I/Q gain and phase errors are present in the analog processing blocks. To take a specific example, in 900 MHz GSM systems channels are spaced 200 kHz apart. If the desired channel was channel 65 at 949.0 MHz, the local oscillator would provide a tuning signal at 948.8 MHz to place channel 65 at the IF of 200 kHz. The 948.8 MHz local oscillator signal would mix channel 63 (at f_{IMAGE}=958.6 MHz) to −200 kHz, which would produce an IF image signal at 200 kHz that may interfere with desired channel 65's IF signal.

During periods of normal operation, image signal synthesizer 130 and amplifier 132 are OFF (i.e., disabled) and the remainder of the components operate as described above. During special calibration periods, however, LNA 102 is OFF and image signal synthesizer 130 and amplifier 132 are ON (i.e., enabled). During these calibration periods, image signal synthesizer 130 and amplifier 132 inject a tone signal at f_{IMAGE} to allow a digital filter in block 122 to adapt coefficients to correct for channel gain and phase errors. This correction removes the significant disadvantage of using the 200 kHz receiver architecture noted above.

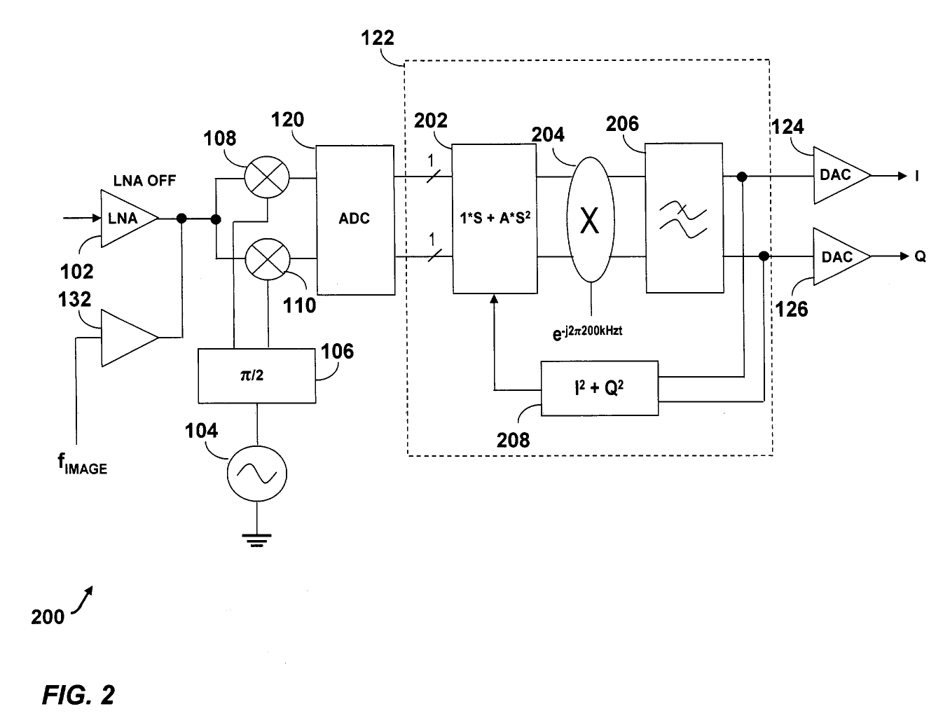

This operation is better understood with reference to FIG. 2, which illustrates in partial block diagram and partial schematic form a portion 200 of radio receiver 100 of FIG. 1 useful in understanding the operation of the image rejection function. During calibration, LNA 102 is off and a tone signal at f_{IMAGE} is injected into the signal processing path through amplifier 132. 200 kHz down-converter and DSP 122 is shown in pertinent detail, and includes an image correction network 202, a mixer block 204, a lowpass filter block 206, and an energy calculator 208. Image correction network 202 has first and second input terminals connected to the first and second output terminals of ADC 120, corresponding first and second output terminals, and a feedback input terminal. Mixer block 204 includes two mixers having input terminals connected to the first and second output terminals of image correction network 202, respectively, corresponding first and second output terminals, and a mixing frequency input terminal for receiving a 200 kHz mixing signal labeled “e^{-jπ200kHzt}”. Lowpass filter block 206 has first and second input terminals connected to the first and second output terminals of mixer block 204, and first and second output terminals providing the first and second output terminals of block 122. Energy calculator 208 has a first input terminal connected to the first output terminal of lowpass filter block 206, a second input terminal connected to the second output terminal of lowpass filter block 206, and an output terminal connected to the feedback input terminal of image correction network 202.

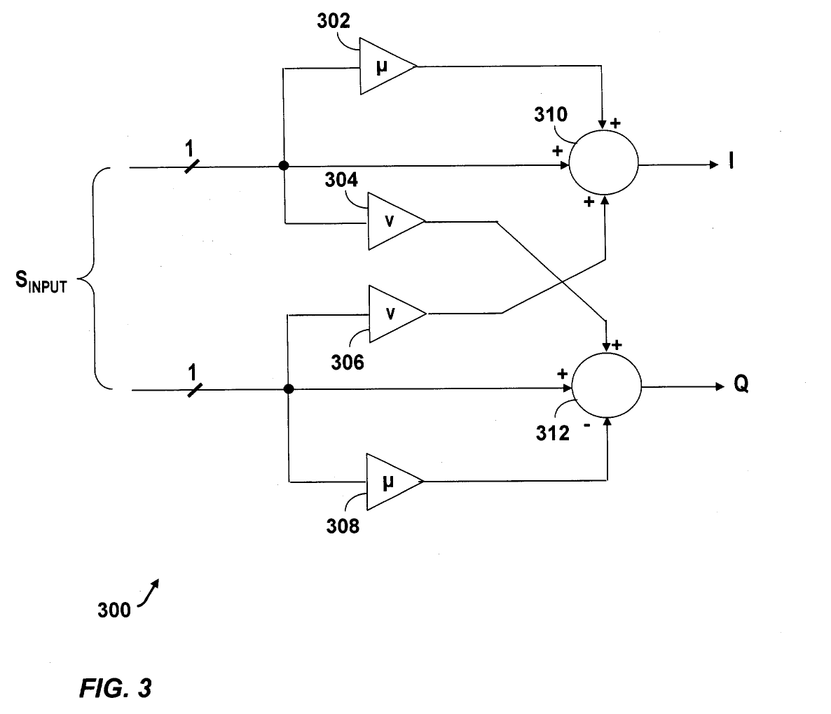

FIG. 3 illustrates in block diagram form an implementation 300 of image correction network 202 of FIG. 2. Image correction network 202 includes multipliers 302, 304, 306, and 308, and summing devices 310 and 312. Multiplier 302 has an input connected to the first output terminal of ADC 120, and an output terminal, and has coefficient μ associated therewith. Multiplier 304 has an input connected to the first output terminal of ADC 120, and an output terminal, and has coefficient v associated therewith. Multiplier 306 has an input connected to the second output terminal of ADC 120, and an output terminal, and has coefficient v associated therewith. Multiplier 308 has an input connected to the second output terminal of ADC 120, and an output terminal, and has coefficient μ associated therewith. Summing device 310 has a first positive input terminal connected to the output terminal of summing device 302, a second positive input terminal connected to the first output terminal of ADC 120, a third positive input terminal connected to the output terminal of multiplier 306, and an output terminal for providing a digital in-phase signal similarly labeled “I”. Summing device 312 has a first positive input terminal connected to the output terminal of multiplier 304, a second positive input terminal connected to the second output terminal of ADC 120, a third negative input terminal connected to the output terminal of multiplier 308, and an output terminal for providing a digital in-phase signal similarly labeled “Q”.

Now considering FIGS. 2 and 3 together, the operation thereof will now be explained. Image correction network 202 performs image correction digitally by transforming the input signal S by adding the complex conjugate of S scaled by a complex constant A to the signal S itself. That is,

S_{OUTPUT}=S_{INPUT}+A·S*_{INPUT}

wherein A=(μ+jv) and S*_{INPUT} is the complex conjugate of S. S_{INPUT} is the complex 1-bit output of ADC 122 (I+jQ), which is a dual sigma-delta ADC. In order to avoid corrupting the signal by imaging quantization noise from ADC 122, ADC 122 needs to have reduced quantization noise in the image band, or a real noise transfer function. Image correction network 202 uses mixer 204 and filter 206 to measure the wanted energy, i.e. the energy in the wanted band, when the tone signal is injected.

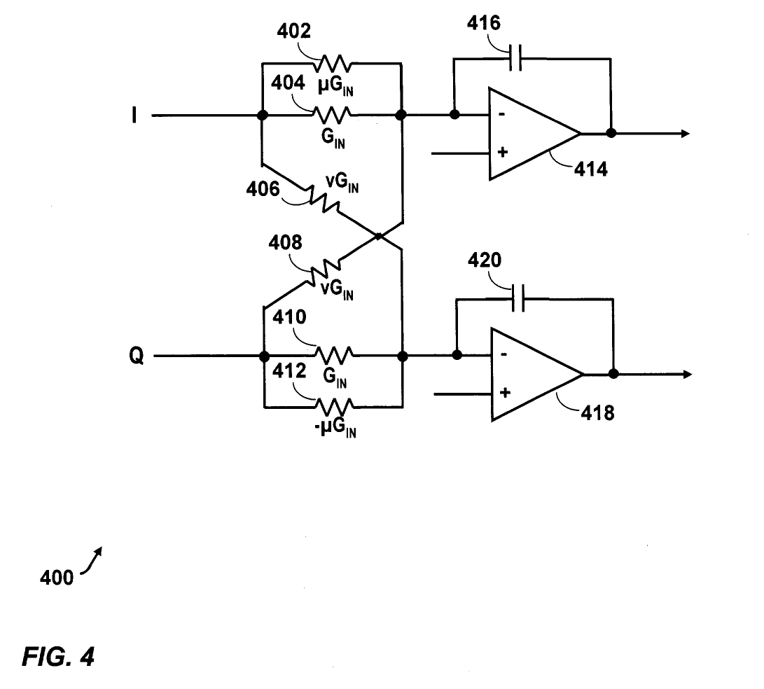

Alternatively, image correction network 202 could allow correction in the analog domain, and FIG. 4 illustrates in partial block diagram and partial schematic form an analog circuit implementation 400 of the image correction network 202 of FIG. 2. Image correction network 400 is a single-ended representation of the first stage of ADC 112. Note that for a discrete time ADC, resistance elements can be formed with switched-capacitor resistor equivalents for the discrete resistors shown.

Image correction network 400 includes resistors 402, 404, 406, 408, 410, and 412, an operational amplifier 414, a capacitor 416, an operational amplifier 418, and a capacitor 420. Resistor 402 has a first terminal for receiving signal I, and a second terminal, and has a value of μG_{IN} associated therewith. Resistor 404 has a first terminal for receiving signal I, and a second terminal, and has a value of GIN associated therewith. Resistor 406 has a first terminal for receiving signal I, and a second terminal, and has a value of vG_{IN} associated therewith. Resistor 408 has a first terminal for receiving signal Q, and a second terminal, and has a value of vG_{IN} associated therewith. Resistor 410 has a first terminal for receiving signal Q, and a second terminal, and has a value of G_{IN} associated therewith. Resistor 412 has a first terminal for receiving signal Q, and a second terminal, and has a value of −μG_{IN} associated therewith. Amplifier 414 has a positive input terminal, a negative input terminal connected to the second terminals of resistors 402, 404, and 408, and an output terminal. Capacitor 416 has a first terminal connected to the negative input terminal of operational amplifier 414, and a second terminal connected to the output terminal of operational amplifier 414. Amplifier 418 has a positive input terminal, a negative input terminal connected to the second terminals of resistors 406, 410, and 412, and an output terminal. Capacitor 420 has a first terminal connected to the negative input terminal of operational amplifier 418, and a second terminal connected to the output terminal of operational amplifier 418. Image correction network 400 can be a fully differential network, and in this case connected to the positive input terminals of operational amplifiers 414 and 418 are resistor networks similar to those formed by resistors 402-412. Note that to implement a negative resistance value the first terminal of resistor 412 is connected to the opposite one of the differential signal pair. Performing the correction in the analog domain using image correction network 400 removes the restriction regarding the quantization noise in the image band and can be combined with the gain function of amplifiers 114 and 116.

Calibration entails determining the best selection of the μ and v coefficients for the best image rejection performance. Thus as shown in FIG. 2 an RF input signal at the f_{IMAGE} frequency is input to pick the μ and v coefficients that produce the minimum energy in the wanted band. The energy in the wanted band is a DC value and its energy is equal to E[I²+Q²], wherein E[I²+Q²] represents the expectation of I²+Q². This value may be averaged to get better results.

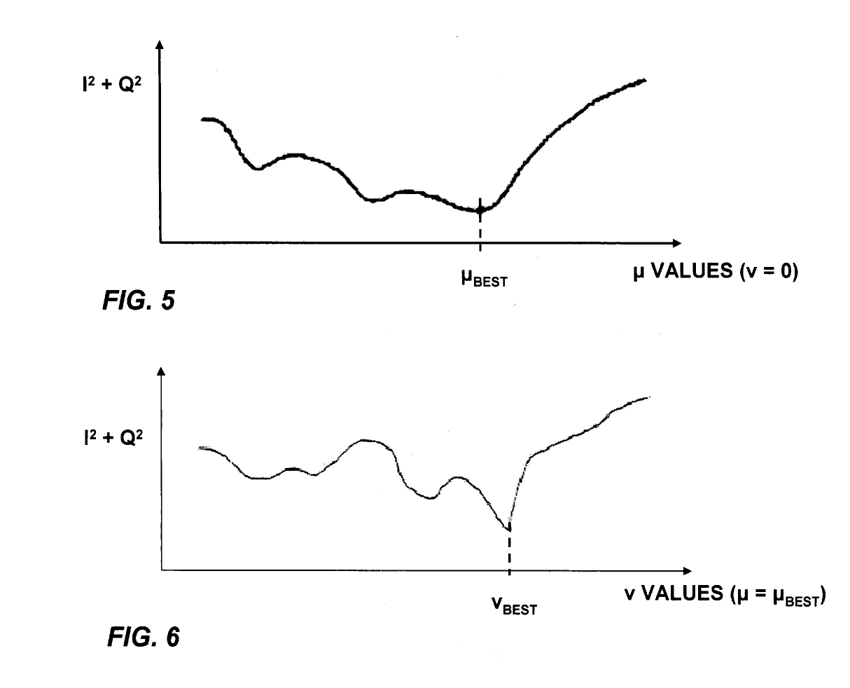

The method used to pick the initial values of the coefficients is better understood with reference to FIGS. 5 and 6. FIG. 5 is a graph illustrating a method for selection of the μ coefficient, in which the horizontal axis represents values of μ and the vertical axis represents energy. μ is walked through all values while v is kept at a constant value, such as 0. The “best” value of μ, μ_{BEST}, is at the minimum energy as shown in FIG. 5. Next v_{BEST} is found, and FIG. 6 is a graph illustrating a method for selection of the v coefficient, in which the horizontal axis represents values of v and the vertical axis represents energy. v is walked through all values while μ is held constant at μ_{BEST}. The “best” value of v, v_{BEST}, is at the minimum energy as shown in FIG. 6. As used herein, the term “best” means a value chosen using an algorithm such as the one described above that tends to yield the optimum or lowest value of I²+Q². The μ_{BEST} and v_{BEST} values only have a weak dependence on each other, so searching for the best μ value (independent of the v coefficient) and likewise for the best v coefficient gives an overall result (μ_{BEST} and v_{BEST} combined) very near the global best value.

This type of search is relatively slower than the incremental search to be described below. Given 5-bit values for μ and v, the algorithm requires 64 measurements. Furthermore if μ and v did have a high dependence on each other such that independent searches on μ and v did not give the overall global best, then this type of search would require 1024 measurements. Under either scenario given the time required for this process, the search procedure is only performed at initialization of the integrated circuit and only at one channel per band. This channel-per-band search procedure assumes that the image performance is constant over the band of operation.

To compensate for thermal drift the coefficients can be periodically updated using a shorter search algorithm. For example when receiver 100 is used in a TDMA system a limited search is done on a per-burst basis. This limited search can be done to measure the in-band signal energy (due to the injected RF signal at the image frequency) for the current μ_{BEST}, v_{BEST} setting and for the μ_{BEST}+1, v_{BEST} setting. On the next burst, the values can be measured with respect to μ_{BEST}−1, v_{BEST} setting. Then the next μ_{BEST} setting can be chosen based on the previous two burst measurements. The same procedure would be performed for the v coefficients. Thus the μ and v coefficients would slowly adapt to temperature changes over several burst cycles with only one or two measurements per burst.

It should be noted that while the receiver has been described in the context of GSM/GPRS, the techniques described herein can be used in other types of over-the-air receivers, such as American TDMA receivers, Personal Handyphone System (PHS), and analog cellular, as well as receivers using different media such as cable modems. Note that while block 12 has been disclosed as a DSP programmed to perform several functions, these functions could be performed by various combinations of DSP and hardware circuitry as well.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A radio frequency (RF) receiver comprising:
an image signal synthesizer having an output for providing a tone signal at an image frequency;
a down converter having an input for receiving an RF input signal during a normal operation period and said tone signal during a calibration period, and an output for providing an input signal at another frequency; and
a signal processor having an input coupled to said output of said down converter, and an output for providing a corrected signal, including:
an image correction network having first and second coefficients, wherein during said calibration period said signal processor determines best values of said first and second coefficients in response to a wanted energy level at baseband of said RF input signal, and during said normal operation period said image correction network filters said RF input signal at said other frequency using said best values.

2. The RF receiver of claim 1 wherein said signal processor further comprises:
a baseband mixer having an input coupled to said output of said image correction network, and an output for providing said baseband signal; and
a lowpass filter having an input coupled to said output of said baseband mixer, and an output for providing a filtered baseband signal.

3. The RF receiver of claim 2 wherein said signal processor further comprises an energy calculator having an input coupled to said output of said lowpass filter, and an output coupled to a feedback input of said image filter.

4. The RF receiver of claim 1 further comprising a low noise amplifier having an input adapted to be coupled to an antenna, and an output for providing said RF input signal.

5. The RF receiver of claim 1 wherein said IF signal comprises an in-phase component and a quadrature component.

6. The RF receiver of claim 5 wherein said signal processor comprises an analog-to-digital converter (ADC) having a first input for receiving said in-phase component, a second input terminal for receiving said quadrature component, and corresponding first and second output terminals.

7. The RF receiver of claim 6 wherein said image correction network is characterized as being a digital network comprising:
a first multiplier having an input coupled to said first output terminal of said ADC, and an output, and has said first coefficient associated therewith;
a second multiplier having an input coupled to said first output terminal of said ADC, and an output, and has said second coefficient associated therewith
a third multiplier having an input coupled to said second output terminal of said ADC, and an output, and has said second coefficient associated therewith;
a fourth multiplier having an input coupled to said second output terminal of said ADC, and an output, and has said first coefficient associated therewith;
a first summing device having a first positive input coupled to said output of said first multiplier, a second positive input coupled to said first output terminal of said ADC, a third positive input coupled to said output of said third multiplier, and an output; and
a second summing device having a first positive input coupled to said output of said second multiplier, a second positive input coupled to said second output terminal of said ADC, a third negative input coupled to said output of said fourth multiplier, and an output terminal.

8. The RF receiver of claim 6 wherein said image correction network is characterized as being an analog network comprising:
a first resistance element having a first terminal for receiving said in-phase component, a second terminal for providing a corrected in-phase component, and a resistance corresponding to said first coefficient;
a second resistance element having a first terminal for receiving said in-phase component, and a second terminal coupled to said second terminal of said first resistance element;
a third resistance element having a first terminal for receiving said in-phase component, a second terminal for providing a corrected quadrature component, and a resistance corresponding to said second coefficient;
a fourth resistance element having a first terminal for receiving said quadrature component, a second terminal coupled to said second terminal of said first resistance element, and a resistance corresponding to said second coefficient;
a fifth resistance element having a first terminal for receiving said quadrature component, and a second terminal coupled to said second terminal of said third resistance element; and
a sixth resistance element having a first terminal for receiving said quadrature component, a second terminal coupled to said second terminal of said third resistance element, and a resistance corresponding to said first coefficient.

9. The RF receiver of claim 8 wherein said analog network forms an input portion of said ADC.

10. The RF receiver of claim 1 further comprising an analog filter coupled to said IF mixer for filtering said IF signal.

11. In a radio frequency (RF) receiver for receiving an RF input signal and converting the RF input signal to an input signal at another frequency, a method for image rejection correction comprising:
generating a tone signal at an image frequency;
mixing said tone signal with an RF tuning signal to provide an image signal;
correcting said image signal using an image correction network having first and second coefficients to provide a corrected signal;
determining a wanted energy level of said corrected signal;
determining best values of said first and second coefficients in response to said wanted energy level of said corrected signal; and
correcting the input signal at the other frequency using said best values in said image correction network.

12. The method of claim 11 wherein correcting said image signal comprises correcting said image signal in a digital network.

13. The method claim 12 wherein correcting said image signal further comprises correcting said image signal in said digital network wherein said digital network has a transfer function equal to S+A·S*, wherein S is equal to a baseband image signal corresponding to said image signal, A is a complex coefficient equal to (μ+jv), wherein μ is said first coefficient and v is said second coefficient, and S* is the complex conjugate of S.

14. The method of claim 11 wherein determining said best values comprises changing said first and second coefficients to minimize said energy level of said corrected signal.

15. The method of claim 14 wherein changing said first and second coefficients further comprises:
determining a minimum energy level of said corrected signal for all values of said first coefficient while said second coefficient is at a constant value, wherein said minimum energy level of said baseband image signal occurs at a best value of said first coefficient; and
determining a minimum energy level of said corrected signal for all values of said second coefficient while said first coefficient has said best value thereof.

16. The method of claim 11 wherein determining said wanted energy level of said corrected signal comprises:
mixing said filtered signal to baseband to provide a baseband image signal; and
determining an energy level of said baseband image signal as said energy level of said filtered signal.

17. The method of claim 11 wherein mixing said tone signal with said RF tuning signal to provide said image signal comprises mixing said tone signal with said RF tuning signal to provide an intermediate frequency (IF) image signal.

18. In a radio frequency (RF) receiver for receiving an RF input signal and converting the RF input signal to an intermediate frequency (IF) input signal before converting the IF input signal to a baseband signal, a method for image rejection correction comprising:
correcting the IF input signal using an image correction network having current values of first and second coefficients to provide a corrected IF input signal;
generating a tone signal at the image frequency;
mixing said tone signal with an RF tuning signal to provide an IF image signal;
changing at least one of said current values to at least one other value;
correcting said IF image signal using said image correction network having said at least one other value to provide a corrected image signal;
determining a wanted energy level of said filtered signal;
comparing said wanted energy level with a prior wanted energy level calculated using said current values;
forming next values as either said current values or said at least one other value based on said comparing; and
correcting the IF input signal using said next values using said filter.

19. The method of claim 18 wherein forming said next values comprises forming said next values as either said current values or said at least one other value based on a lower one of said wanted energy level and said prior wanted energy level.

20. The method of claim 18 wherein determining said wanted energy level of said corrected signal comprises:
mixing said corrected signal to baseband to provide a baseband signal;
filtering image energy in said baseband signal; and determining an energy level of said baseband signal as said energy level of said corrected signal.
